(19) United States
(12) Patent Application Publication
(10) Pub. No.: US 2026/0322644 A1
(43) Pub. Date: Oct. 15, 2026

(54) METHOD OF EXCHANGING IDENTIFICATION DATA AMONG WIRELESS INTERFACES IN AN HVAC SYSTEM

(71) Applicant: Mitsubishi Electric US, Inc., Cypress, CA (US)

(72) Inventor: Rodney OLSON, Cypress, CA (US)

(21) Appl. No.: 19/179,724

(22) Filed: Apr. 15, 2025

(51) Int. Cl. H04L 12/28; F24F 11/63

(52) U.S. Cl. CPC H04L 12/2816; F24F 11/63; H04L 2012/2841

(57) ABSTRACT

The present disclosure relates to a method for operating a heating, ventilating, and cooling (HVAC) system comprising one or more outdoor units (ODUs), multiple indoor units (IDUs), and several wireless interfaces. The method involves automatically transmitting unique identification data from a first ODU to a first IDU via a communication line, then relaying this data from the first IDU to a first wireless interface through another communication line. Subsequently, the first wireless interface wirelessly transmits the ODU identification data to a group of additional wireless interfaces. The first wireless interface also receives a set of ODU identification data from these additional wireless interfaces, which identifies the associated ODU for each respective IDU. This method ensures efficient communication and identification within the HVAC system, facilitating seamless operation and management of the interconnected units.

### TECHNICAL FIELD

The disclosed methods relate generally to exchanging identification data for a plurality of outdoor units (ODUs) in a heating ventilation and air conditioning (HVAC) system with wireless interfaces associated with those ODUs. More specifically, the disclosed methods relate to automatically providing the wireless interfaces with the ODU identification data stored by on indoor unit (IDU) associated with a given ODU and the wireless interface.

### BACKGROUND

Traditional HVAC systems have relied on wired communication networks to connect outdoor units (ODUs) with indoor units (IDUs). These systems typically use dedicated communication lines to transmit control signals and identification data between the ODUs and IDUs. While effective in ensuring reliable communication, these wired systems often require extensive installation efforts and can be costly to implement, especially in large buildings with multiple units. Additionally, the inflexibility of wired connections can pose challenges when reconfiguring or expanding the system to accommodate changes in building layout or usage.

In recent years, there has been a shift towards incorporating wireless communication technologies into HVAC systems to address some of the limitations of wired networks. Wireless interfaces have been introduced to facilitate communication between ODUs and IDUs, allowing for more flexible system configurations and easier installation. These wireless systems often use protocols such as Zigbee, Wi-Fi, or Bluetooth to transmit data.

In addition, some HVAC systems include multiple ODUs, each of which may in turn be associated with multiple IDUs. Under certain circumstances, it is beneficial for there to be a record stored in memory of which IDUs are associated with which corresponding ODUs. For example, sometimes it is necessary to take action with respect to all IDUs connected to a single ODU. Presently, this information is entered manually into a memory inside the HVAC system. However, such manual entry requires additional setup time, leads to potential data entry errors, and increases the final set up cost of the HVAC system.

It therefore may be desirable to provide a method by which an HVAC system can automatically trade identification information and determine which of multiple IDUs are associated with which of multiple ODUs in an HVAC system.

### SUMMARY OF THE INVENTION

In some aspects, the techniques described herein relate to a method of operating a heating, ventilating, and cooling (HVAC) system having one or more outdoor units (ODUs), a plurality of indoor units (IDUs), and a plurality of wireless interfaces, the method including: automatically sending first ODU identification data that uniquely identifies a first ODU from the first ODU to a first IDU that is connected to the first ODU via a first communication line; sending the first ODU identification data from the first IDU to a first wireless interface connected to the first IDU via a second communication line; wirelessly sending the first ODU identification data from the first wireless interface to a first group of one or more additional wireless interfaces; and receiving at the first wireless interface a first set of ODU identification data from the first set of wireless interfaces wherein the first ODU is one of the one or more ODUs, the first IDU is one of the plurality of IDUs, the first wireless interface is one of the plurality of wireless interfaces, the first group of wireless interfaces includes all of the plurality of wireless interfaces except for the first wireless interface, and the first set of ODU identification data identifies for each respective IDU in the first group of wireless interfaces a one of the one or more ODUs that is associated with the respective IDU.

In some aspects, the techniques described herein relate to a method, further including: storing the first ODU identification data in a first IDU memory in the first IDU.

In some aspects, the techniques described herein relate to a method, further including: storing the first ODU identification data in a first wireless interface memory in the first wireless interface.

In some aspects, the techniques described herein relate to a method, wherein the first ODU identification data includes a model and serial number of the first ODU.

In some aspects, the techniques described herein relate to a method, further including: prior to the sending of the first ODU identification data from the first IDU to the first wireless interface, sending a request from the first wireless interface to the first IDU for transmission of the first ODU identification data.

In some aspects, the techniques described herein relate to a method, wherein the sending of the first ODU identification data to the first wireless interface is performed automatically by the first IDU.

In some aspects, the techniques described herein relate to a method, further including: automatically sending the first ODU identification data to a second IDU that is connected to the first ODU via a third communication line; automatically sending the first ODU identification data from the second IDU to a second wireless interface connected to the second IDU via a fourth communication line; wirelessly sending the first ODU identification data from the second wireless interface to a second group of one or more additional wireless interfaces; and receiving at the second wireless interface a second set of ODU identification data from the second set of wireless interfaces wherein the second IDU is one of the plurality of IDUs, the second wireless interface is one of the plurality of wireless interfaces, the second group of wireless interfaces includes all of the plurality of wireless interfaces except for the second wireless interface, and the second set of ODU identification data identifies for each respective IDU in the second group of wireless interfaces a one of the one or more ODUs that is associated with the respective IDU.

In some aspects, the techniques described herein relate to a method, further including: automatically sending second ODU identification data that uniquely identifies a second ODU from the second ODU to a third IDU that is connected to the second ODU via a fifth communication line; automatically sending the second ODU identification data from the third IDU to a third wireless interface connected to the third IDU via a sixth communication line; wirelessly sending the second ODU identification data from the third wireless interface to a third group of one or more additional wireless interfaces; and receiving at the third wireless interface a third set of ODU identification data from the third set of wireless interfaces wherein the second ODU is one of the one or more ODUs, the third IDU is one of the plurality of IDUs, the third wireless interface is one of the plurality of wireless interfaces, the third group of wireless interfaces includes all of the plurality of wireless interfaces except for the third wireless interface, and the third set of ODU identification data identifies for each respective IDU in the third group of wireless interfaces a one of the one or more ODUs that is associated with the respective IDU.

In some aspects, the techniques described herein relate to a method, wherein the second ODU identification data includes a model and serial number of the second ODU.

In some aspects, the techniques described herein relate to a method, further including: receiving a demand response communication from an external system at a router wirelessly connected to the first wireless interface; forwarding the demand response communication to the first wireless interface; comparing the first ODU identification data with the first set of ODU identification data; determining a first subset of wireless interfaces from among the first group of wireless interfaces that are connected to the first ODU based on the comparing of the first ODU identification data with the first set of ODU identification data; and coordinating at the first wireless interface a response to the demand response communication with the first subset of wireless interfaces.

In some aspects, the techniques described herein relate to a method, wherein the demand response communication limits use of power by the first ODU.

In some aspects, the techniques described herein relate to a method, wherein the demand response communication sets a maximum temperature offset associated with the first ODU.

In some aspects, the techniques described herein relate to a method, wherein the demand response communication provides instructions regarding use of a supplemental heating circuit associated with the first ODU.

In some aspects, the techniques described herein relate to an method of operating a first wireless interface in a heating, ventilating, and cooling (HVAC) system, the method including: receiving first ODU identification data that uniquely identifies a first ODU in the HVAC system from a first IDU that is connected to both the first ODU and the first wireless interface; wirelessly sending the first ODU identification data to a plurality of additional wireless interfaces associated with the HVAC system; and receiving a first set of ODU identification data from the plurality of additional wireless interfaces wherein the first set of ODU identification data identifies for each corresponding one of the plurality of additional wireless interfaces an ODU that is associated with a respective IDU associated with the corresponding one of the plurality of additional wireless interfaces.

In some aspects, the techniques described herein relate to a method, further including: storing the first ODU identification data in a first wireless interface memory in the first wireless interface.

In some aspects, the techniques described herein relate to a method, wherein the first ODU identification data includes a model and serial number of the first ODU.

In some aspects, the techniques described herein relate to a method, further including: prior to receiving the first ODU identification data from the first IDU, sending a request to the first IDU for transmission of the first ODU identification data.

In some aspects, the techniques described herein relate to a method, further including: receiving a demand response communication from a router wirelessly in the HVAC system connected to the first wireless interface; comparing the first ODU identification data with the first set of ODU identification data; determining a first subset of wireless interfaces from among the plurality of additional wireless interfaces that are connected to the first ODU based on the comparing of the first ODU identification data with the first set of ODU identification data; and coordinating at the first wireless interface a response to the demand response communication with the first subset of wireless interfaces.

In some aspects, the techniques described herein relate to a method, wherein the demand response communication limits use of power by the first ODU.

In some aspects, the techniques described herein relate to a method, wherein the demand response communication sets a maximum temperature offset associated with the first ODU.

In some aspects, the techniques described herein relate to a method, wherein the demand response communication provides instructions regarding use of a supplemental heating circuit associated with the first ODU.

### BRIEF DESCRIPTION OF THE DRAWINGS

The accompanying figures, where like reference numerals refer to identical or functionally similar elements and which together with the detailed description below are incorporated in and form part of the specification, serve to further illustrate an exemplary embodiment and to explain various principles and advantages in accordance with the present disclosure.

FIG. 1 is a block diagram of an HVAC system according to an exemplary device;

FIG. 2 is a block diagram of an IDU from the HVAC system of FIG. 1 according to an exemplary device;

FIG. 3 is a block diagram of a wireless interface from the HVAC system of FIG. 1 according to an exemplary device;

FIG. 4 is a flowchart of a process of ODU identification data being shared throughout an HVAC system according to an exemplary method;

FIG. 5 is a flowchart of a process of requesting wireless interface processing ODU identification data in an HVAC system according to an exemplary method;

FIG. 6 is a flowchart of an HVAC system processing a demand response communication according to an exemplary method; and

FIG. 7 is a flowchart of a process of a target wireless interface identifying which other wireless interfaces in an HVAC system are associated with the same ODU as the target wireless interface according to an exemplary method.

### DETAILED DESCRIPTION

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

In one or more embodiments, a non-transitory computer readable medium may be provided which comprises instructions for execution by a computer, the instructions including a computer-implemented method for controlling an air-conditioning system to defrost a condenser coil, as described above. The non-transitory computer readable medium may comprise, for example, a read-only memory (ROM), a random-access memory (RAM), a programmable ROM (PROM), and/or an electrically erasable read-only memory.

### HVAC System

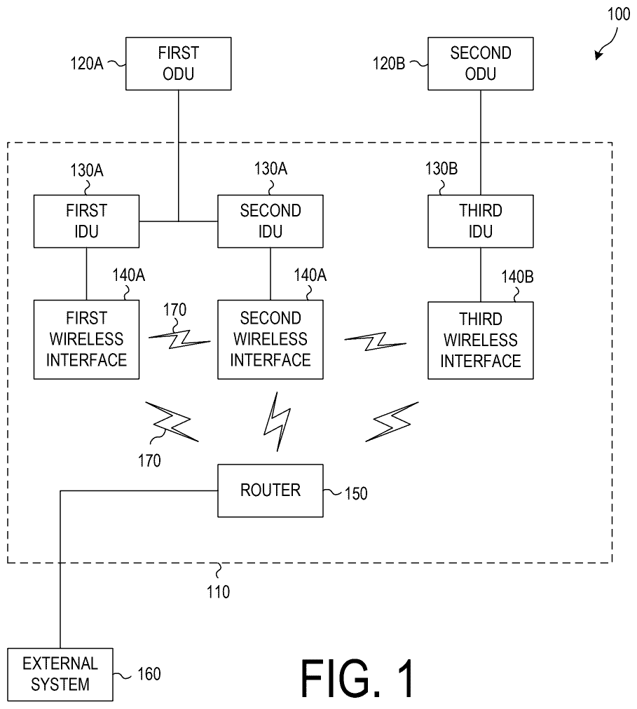

FIG. 1 is a block diagram of an HVAC system 100 according to an exemplary device. As shown in FIG. 1, the HVAC system 100 is formed to control the heating, ventilation, and air-conditioning within a structure 110. The HVAC system 100 includes first and second ODUs 120A, 120B, (generically referred to as ODUs 120), first, second, and third IDUs 130A, 130B, 130C, (generically referred to as IDUs 130), first, second, and third wireless interfaces 140A, 140B, 140C, (generically referred to as ODUs 120) wireless interfaces 140, and a router 150. The HVAC system 100 communicates with an external system 160.

The ODUs 120 are formed outside of the structure 110 and each operates to exchange heat between a refrigerant passing through the corresponding ODU 120 and external air passing through the corresponding ODU 120. Each ODU 120 is connected to at least one IDU 130 through both refrigerant pipes and communication lines. The communication lines can be wired, wireless, or a combination of the two.

The IDUs 130 are formed inside the structure 110 and operate to exchange heat between a refrigerant passing through the corresponding IDU 130 and internal air passing through the corresponding IDU 130.

By passing refrigerant between the various ODUs 120 and their respective IDUs 130, the HVAC system 100 can exchange heat between the external air and the internal air via the refrigerant.

The communication lines between the ODUs 120 and their respective IDUs 130 allow information to be passed between these elements of the HVAC system 100

The wireless interfaces 140 are each connected to a corresponding IDU 130 via a communication line such that each IDU 130 has a corresponding wireless interface 140 connected to it. Although the line connecting each IDU 130 to a corresponding wireless interface 140 is a wired line in the exemplary device, alternate devices could employ a wireless connection between the IDUs 130 and their corresponding wireless interfaces 140. In some alternate devices, the wireless interface 140 can be integrated with the IDU 130 or formed in the IDU 130 such that the lines connecting each IDU 130 to its corresponding wireless interface 140 will be communication lines formed in the combined IDU 130/wireless interface 140 or internal to the IDU 130.

The wireless interfaces 140 operate to pass information between a corresponding IDU 130 and the router 150. In this way, the router 150 can pass information to and from each of the IDUs 130. In various exemplary devices, the wireless interfaces 140 can use a protocol such as Zigbee, Wi-Fi, Bluetooth, or any suitable wireless protocol to transmit data to and from the router 150.

The router 150 contains circuitry allowing it to communicate wirelessly with the wireless interfaces 140 and via the external system 160 using either a wired or wireless connection. In different exemplary devices the router 150 could be connected to the external system 160 via a wired connection to a broadband Internet connection, a wired connection to a telephone line, a wireless connection to the Internet, a wireless connection to a cellular telephone line, or any suitable wired or wireless connection.

The external system 160 is a system that provides information and/or instructions to the HVAC system 100 via the router 150 and may receive information from the HVAC system 100 via the router 150. In various exemplary systems, the external system 160 can be an external website, a control system connected via a wired or wireless telephone system, or any appropriate system that provides information and/or instructions to the HVAC system 100 and receives information from the HVAC system 100.

In some exemplary devices, the external system 160 may be a government system, a regulatory system, a power company system, or an independent control system that may identify to the HVAC system 100 via a demand response communication that a curtailment event has occurred. Such a curtailment event may be a requirement that the HVAC system 100 minimize electrical power consumption within certain parameters. This might occur, for example, when demand on an electrical grid was particularly high or the electrical grid was suffering from an emergency that restricted its output.

In some exemplary systems, the external system 160 may be an HVAC smart control system that communicates with a government system, a regulatory system, or a power company system. The HVAC smart control system include a wired or wireless interface, software operating on an external service such as Amazon Web Services, and application on a user's smart phone.

Since the structure 110 may be divided into multiple zones (not shown) for heating, cooling, and ventilation, multiple IDUs 130 may be provided, e.g., one for each zone. For a variety of reasons, a single ODU 120 may not be able to service all the IDUs 130 in the HVAC system 100. For example, a single ODU 120 might not have the capacity to handle all the requirements for all the IDUs 130 in the HVAC system 100; the structure 110 might be large enough that the placement of the IDUs 130 makes it impossible for a single ODU 120 to be close enough to circulate refrigerant through all the IDUs 130; it may be less expensive to install shorter refrigeration lines to multiple ODU's 120 instead of having to run refrigeration lines through a large portion of the building to connect multiple IDUs 130 to a single ODU 120; or the ODU 120 refrigerant line lengths may be longer than acceptable to route from any given IDU 130 back to.

As shown in the exemplary device of FIG. 1, a first ODU 120A is connected to a first IDU 130A and a second IDU 130B, and a second ODU 120B is connected to a third IDU 130C. However, this is by way of example only. Different exemplary devices can have differing numbers of ODUs 120 and each ODU 120 may have a differing number of IDUs 130 connected to it. The precise number of ODUs 120 in an HVAC system and the number of IDUs 130 connected to each ODU 120 will vary according to the needs of the HVAC system.

Each of the ODUs 120 and each of the IDUs 130 can be identified by unique identification data. In some exemplary systems, this identification data may be a model and serial number for each corresponding ODU 120 or IDU 130.

During operation of the HVAC system 100, it can be advantageous for associated control circuitry to know or be able to easily find out which IDUs are connected to which ODUs. In particular, the various exemplary systems may store in each of the IDUs 130 identification data for the ODU 120 that the corresponding IDU 130 is connected to. Similarly various exemplary embodiments may store in each of the wireless interfaces 140 identification data for the ODU 120 that the corresponding wireless interface 140 is associated with.

One way to get this identification data stored in an IDU 130 or wireless interface 140 is for an operator or installer to manually enter of that data into a memory in the IDUs 130/wireless interfaces 140 when the HVAC system 100 is installed in the structure 110. Another way to get this identification data stored in an IDU 130 is for each ODU 120 to automatically transmit its corresponding identification data to each of the IDUs 130 that it is connected to, and for each IDU 132 automatically or by request transmit that identification data to its associated wireless interface 140. Automatic transmission can occur when the HVAC system 100 is initially set up, or at any time it would be appropriate, such as when the ODU 120 is first turned on, when the ODU 120 makes contact with the corresponding IDU 130, at a periodic time, etc.

### Indoor Unit

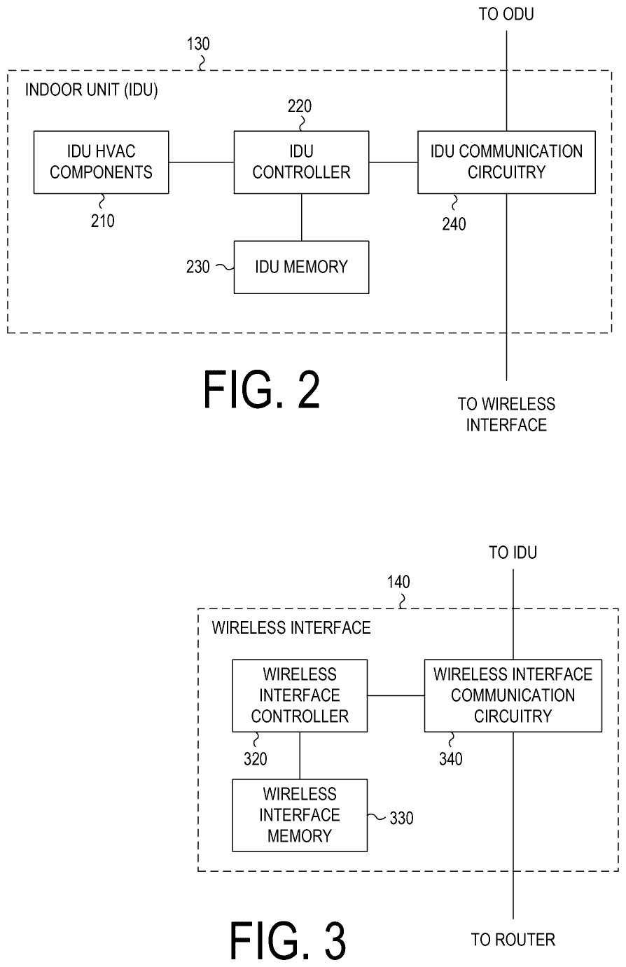

FIG. 2 is a block diagram of an IDU 130 from the HVAC system 100 of FIG. 1 according to an exemplary device. As shown in FIG. 2, each IDU 130 includes IDU HVAC components 210, and IDU controller 220, an IDU memory 230, and IDU communication circuitry 240.

The IDU HVAC components 210 may include all the parts of the IDU 130 that are required for its air-conditioning function. This can include heat exchangers, a compressor, various refrigerant pipes, various valves, etc.

The IDU controller 220 is configured to control the operation of the IDU 130 and can include a processor that generates signals to control the IDU HVAC components 210 and the IDU communication circuitry 240.

The processor can be a microprocessor (e.g., a central processing unit), an application-specific integrated circuit (ASIC), or any suitable device for controlling the operation of the IDU 130.

The IDU memory 230 stores information and operation programs used by the IDU controller 220 and can include a read-only memory (ROM), a random-access memory (RAM), an electronically programmable read-only memory (EPROM), an electrically erasable programmable read only memory (EEPROM), flash memory, or any suitable memory device.

The IDU communications circuitry 240 is configured to transmit and receive communications to and from a corresponding ODU 120 and to and from a corresponding wireless interface 140.

The connections from the IDU communication circuitry 240 could be wired or wireless between the IDU communication circuitry 240 and the ODU 120 and between the IDU communication circuitry 240 and the wireless interface 140. The connections from the IDU communication circuitry 240 to each of these elements may be the same or maybe different in various exemplary devices.

### Wireless Interface

FIG. 3 is a block diagram of a wireless interface 140 from the HVAC system 100 of FIG. 1 according to an exemplary device. As shown in FIG. 3, each wireless interface 140 includes a wireless interface controller 320, a wireless interface memory 330, and wireless interface communication circuitry 340.

The wireless interface controller 320 is configured to control the operation of the wireless interface communication circuitry 340 and can include a processor that generates signals to control the wireless interface communication circuitry 340.

The processor can be a microprocessor (e.g., a central processing unit), an application-specific integrated circuit (ASIC), or any suitable device for controlling the operation of all or part of the wireless interface 140.

The wireless interface memory 330 stores information and operation programs used by the wireless interface controller 320 and can include a read-only memory (ROM), a random-access memory (RAM), an electronically programmable read-only memory (EPROM), an electrically erasable programmable read only memory (EEPROM), flash memory, or any suitable memory device.

The wireless interface communications circuitry 340 is configured to transmit and receive communications to and from a corresponding IDU 130 and to and from the router 150.

The connections from the wireless interface communication circuitry 340 to the corresponding IDU 130 could be wired or wireless. The connections from the wireless interface communication circuitry 340 to the router 150 are wireless connections in the disclosed system.

Although the disclosed devices show the use of a wireless connection between each wireless interface 140 and the router 150, this is by way of example only. Alternate systems could connect the wireless interfaces 140 with the router 150 via a wired connection.

### Curtailment Event

As noted above, in some situations, it will be necessary to limit the power consumption of an HVAC system due to external limitations, e.g., high power demand, power outages, or other emergencies. In such circumstances, a demand response will be sent to each HVAC system 100 from the external system 160 identifying that a curtailment event has occurred and providing any necessary detail regarding how curtailment event should be handled.

Such a curtailment event typically restricts how much power each ODU 120 may consume. Restrictions for a given ODU 120 may affect the operation of all the IDUs 130 connected to that ODU 120, and circumstances surrounding each IDU 130 may affect the operation of the associated ODU 120 as well as the operation of any other IDU 130 connected to that associated ODU 120. As a result, it is necessary for the HVAC system 100 to be able to determine which IDUs 130 are connected to a given ODU 120 so that information can properly be communicated with each appropriate IDU 130 during a curtailment event.

For example, there may be certain circumstances in which power restrictions on ODU 120 may be relaxed. In some situations, a maximum temperature offset is provided for each IDU 130, which represents the maximum allowable temperature offset between a setpoint temperature and the actual temperature measured in a particular zone in an HVAC system 100 (which zones are each associated with one of the IDUs 130). When a measured temperature in a given zone differs from the temperature set point associated with the corresponding IDU 130 by more than the maximum temperature offset (below in a heating operation, above in a cooling operation), the power limits on the associated ODU 120 may be relaxed or removed. Similarly, in a heating operation when the actual temperature measured in a particular zone is lower than the temperature set point associated with the corresponding IDU 130 by more than the maximum temperature offset, the HVAC system 100 may be instructed to engage a supplemental heating system (e.g., a furnace), or to discontinue the curtailment event and hold a maximum temperature offset for all zones connected to the same ODU 120.

Furthermore, if a customer overrides a power limiting event by any means (e.g., changing a setpoint temperature) the HVAC system 100 may need to inform the external system 160 that the power limiting has been overwritten, set the setpoint temperature to its original value, and eliminate any power limiting for the associated ODU 120. This must be done at each wireless interface 140 associated with the given ODU 120. As a result, it must be possible to determine which wireless interfaces 140 should operate in this manner.

Furthermore, when circumstances surrounding one IDU 130 change the operation of its associated ODU 120 during a curtailment event, it may be necessary to change the operation of all the IDUs 130 also associated with that ODU 120. Therefore, it will be necessary for each wireless interface 140 to be able to quickly ascertain which other wireless interfaces 140 it needs to communicate with regarding the change in operation of the corresponding ODU 120.

One way to achieve this sharing of identification data is to have an operator or installer manually enter ODU identification data into each IDU memory 230 for an IDU 130 connected to a particular ODU 120 and/or into each wireless interface memory 334 a wireless interface 140 associated with a particular ODU 120. In this way, each IDU 130 and/or wireless interface 140 has the information it needs.

### Sharing ODU Identification Data Throughout an HVAC System

Another way for ODU identification data to be shared throughout an HVAC system is for each ODU 120 to automatically provide that information to each IDU 130 that it is connected to and for each IDU 132 either automatically or at request provide that information to its associated wireless interface 140. Such sharing of this identification data will save installation time and installation cost and can reduce the possibility of incorrect ODU identification data being entered into an IDU 130 and/or wireless interface 140.

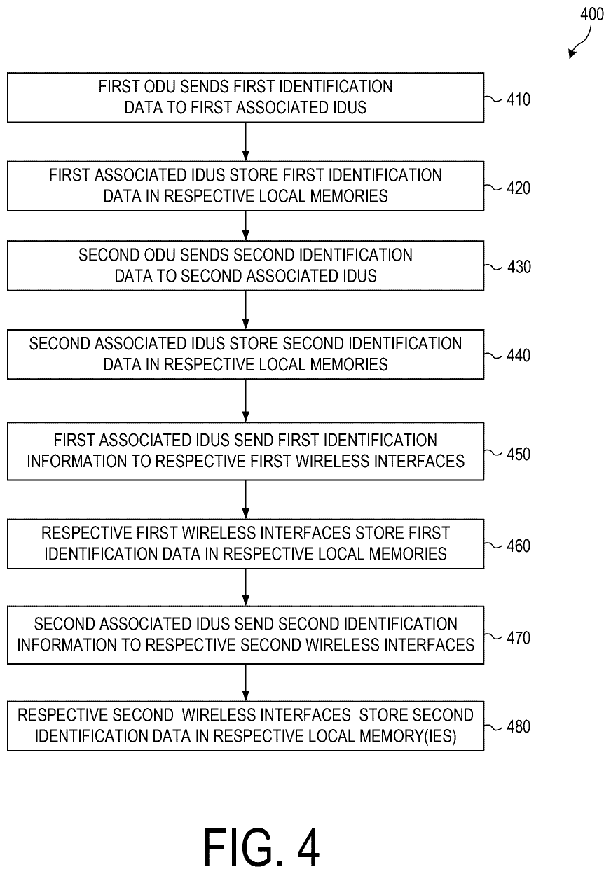

FIG. 4 is a flowchart 400 of a process of ODU identification data being shared throughout an HVAC system according to an exemplary method.

As shown in FIG. 4, a first ODU sends first ODU identification data to first associated IDUs (410). In the exemplary device of FIG. 1, this can be achieved by having a first ODU 120A send first ODU identification data to first and second IDUs 130A, 130B.

The first associated IDUs then store the first ODU identification data in respective local memories (420). In the exemplary device of FIG. 1 this can be achieved by having each of the first and second IDUs 130A, 130B store the first ODU identification data in a corresponding IDU memory 230.

A second ODU sends second ODU identification data to second associated IDUs (430). In the exemplary device of FIG. 1, this can be achieved by having a second ODU 120B send second ODU identification data to a third IDU 130C.

The second associated IDUs then store the second ODU identification data in respective local memories (440). In the exemplary device of FIG. 1 this can be achieved by having the third IDU 130C store the second ODU identification data in a corresponding IDU memory 230.

First associated IDUs then send the first ODU identification data to respective first wireless interfaces (450). In the exemplary device of FIG. 1, this can be achieved by having a first and second IDUs 130A, 130B send the first ODU and data to the first and second wireless interfaces 140A, 140B, respectively.

The respective first wireless interfaces then store the first ODU identification data in respective local memories (460). In the exemplary device of FIG. 1 this can be achieved by having each of the first and second wireless interfaces 140, 140B store the first ODU identification data in a corresponding wireless interface memory 330. Although not specifically mentioned, the first wireless interfaces also store identification data relating to the other wireless interfaces connected through their corresponding IDU to the same ODU.

Second associated IDUs then send the second ODU identification data to respective second wireless interfaces (470). In the exemplary device of FIG. 1, this can be achieved by having a third IDU 130C send the second ODU data to the third wireless interface 140C.

The respective second wireless interfaces then store the second ODU identification data in respective local memories (480). In the exemplary device of FIG. 1 this can be achieved by having the third wireless interface 140C store the second ODU identification data in a corresponding wireless interface memory 330. Although not specifically mentioned, the second wireless interfaces also store identification data relating to the other wireless interfaces connected through their corresponding IDU to the same ODU.

Although the description of the process described with respect to FIG. 4 refers to first associated IDUs and second associated IDUs in plural form, in each case the first and second associated IDUs may one or both refer to a single IDU.

In addition, although the process described with respect to FIG. 4 shows each IDU 130 transmitting its associated ODU identification data to a corresponding wireless interface 140 and having each wireless interface 140 store that ODU identification data in memory, these operations may be omitted in some exemplary methods. For example, if the wireless interfaces 140 are configured to request the ODU information data at need from the IDUs 130 it may not be necessary for them to automatically receive and store that ODU information data.

### Processing ODU Identification Data in an HVAC System

When it is necessary for the wireless interfaces 140 to communicate a demand request to a particular subset of IDUs 130 associated with a given ODU 120, the wireless interfaces 140 must determine which wireless interfaces 140 are connected to the required ODU 120. In some exemplary devices, they can do so by requesting the information that they need from the other wireless interfaces 140.

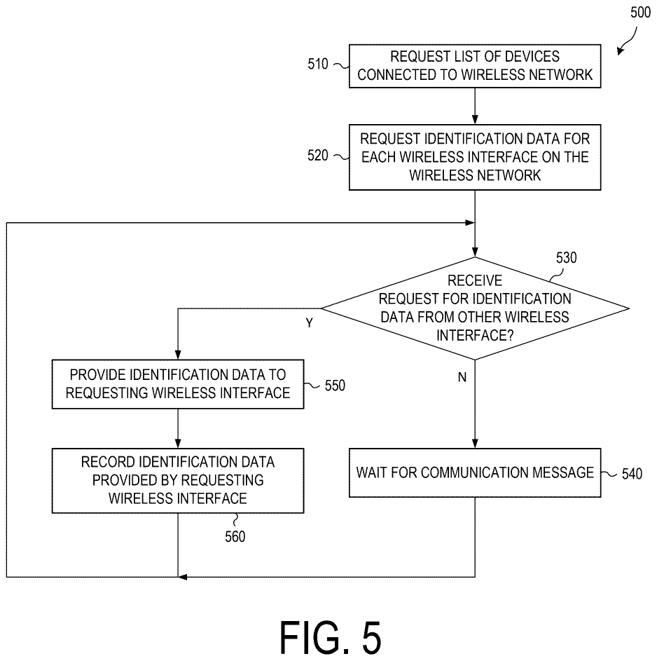

FIG. 5 is a flowchart 500 of a process of requesting wireless interface processing ODU identification data in an HVAC system according to an exemplary method.

As shown in FIG. 5, operation begins when a target wireless interface in the HVAC system requests a list of devices it is connected to (510). In the disclosed system, the target wireless interface will have information regarding the devices to which it is connected, likely all the wireless interfaces in the HVAC system, stored in a memory.

The target wireless interface then requests identification data for each other wireless interface on the wireless network formed in the HVAC system (520).

Having acquired this information, the target wireless interface determines whether it has received a request from one of the other wireless interfaces (530).

If it has not received such a request, operation will wait for a communication message, processing the communication message in operation 530 if the communication message is a request for identification data from another wireless interface (540). Although not shown in FIG. 5, if a communication message other than a request for identification data from another wireless interface arrives, the target wireless interface will process that data message in an appropriate manner.

If the target wireless interface has received a request for identification data from another wireless interface, it will provide the identification data to the requesting wireless interface (550) and will record the identification data provided by the requesting wireless interface in a local memory (560). Thus, the target wireless interface will both receive and provide corresponding identification data during this process.

In this way, the wireless interfaces can quickly and automatically exchange identification data for the devices in the HVAC system such that each wireless interface will know which wireless interfaces and IDUs are connected to which ODUs.

### Processing a Demand Response Communication in an HVAC System

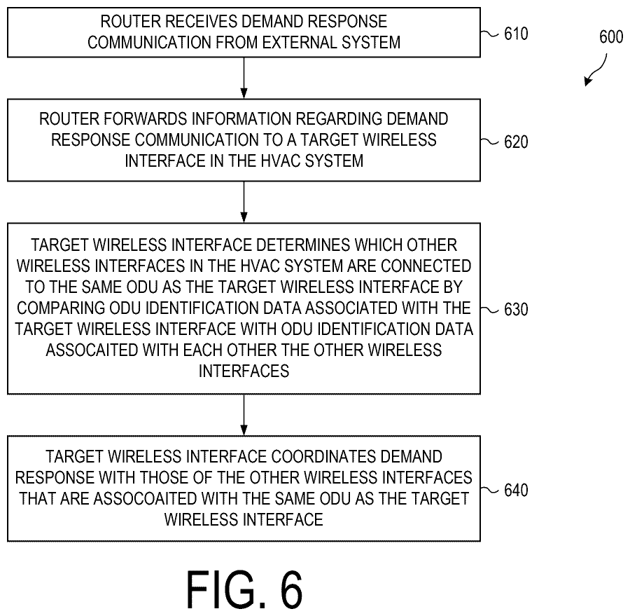

FIG. 6 is a flowchart 600 of an HVAC system processing a demand response communication according to an exemplary method.

As shown in FIG. 6, a router first receives a demand response communication from an external system (610).

The router then forwards information regarding the demand response communication to a target wireless interface in the HVAC system (620).

The target wireless interface then determines which other wireless interfaces in the HVAC system are connected to the same ODU as the target wireless interface. It does so by comparing the ODU identification data associated with the target wireless interface with ODU data associated with each other of the other wireless interfaces (630).

The target wireless interface then coordinates the demand response with those of the other wireless interfaces that are associated with the same ODU is the target wireless interface (640).

In this way, when a demand response communication is received by a router and sent to a target wireless interface, that target wireless interface can automatically coordinate its response with all the other wireless interfaces associated with the same ODU as the target wireless interface that received the demand response communication.

### Identifying Other Wireless Interfaces Associated with the Same ODU in an HVAC System

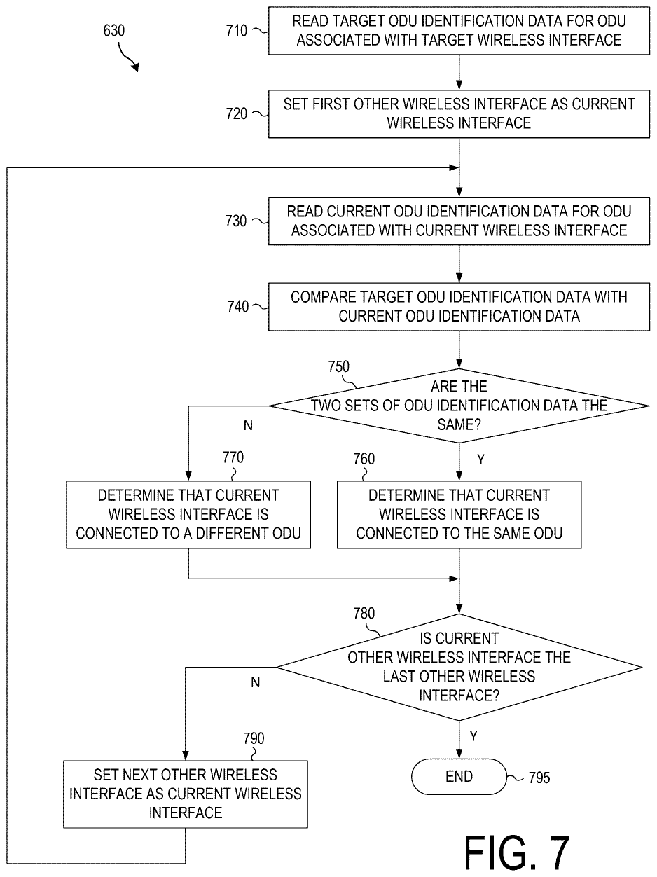

FIG. 7 is a flowchart 630 of a process of a target wireless interface identifying which other wireless interfaces in an HVAC system or associated with the same ODU as the target wireless interface according to an exemplary method.

As shown in FIG. 7, the target wireless interface first reads target ODU identification data associated with the target wireless interface (710).

A first other wireless interface is set as a current wireless interface (720). The first other wireless interface is chosen from a group of other wireless interfaces that includes all the wireless interfaces in the HVAC system except for the target wireless interface.

Current ODU data is then read for the ODU associated with the current wireless interface (730). For example, initially this will be the ODU associated with the first wireless interface.

The target ODU data is then compared with the current ODU information data (740) and it is determined if the two sets of ODU and data are the same (750).

If it is determined that the two sets of ODU identification data are the same, then it is further determined that the current wireless interface is connected to the same ODU as the first other ODU (760).

If, however, it is determined that the two sets of ODU identification data are not the same, then it is further determined that the current wireless interface is connected to a different ODU is the first other ODU (770).

It is then determined whether the current other wireless interface is the last other wireless interface (780). In other words, it is determined whether the operation has considered all the other wireless interfaces.

If it is determined that the current other wireless interface is not the last other wireless interfaces, then the next other wireless interface is set to be the current wireless interface (790) and processing returns to operation 730 where current ODU identification data for the ODU associated with the current wireless interface is read. For example, after processing finishes for the first other wireless interface, the current wireless interface is changed from the first other wireless interface to the second other wireless interface. A similar operation occurs as the method moves through the other wireless interfaces.

If, however, it is determined that the current other wireless interfaces is the last other wireless interfaces, then the process ends (795).

In this way, a target wireless interface can quickly and automatically determine which other wireless interfaces are associated with same ODU as the target wireless interface. This allows the target wireless interface to properly communicate with the other wireless interfaces associated with the same ODU as it is associated with, which allows it to coordinate responses to certain demand requests.

### CONCLUSION

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

1. A method of operating a heating, ventilating, and cooling (HVAC) system having one or more outdoor units (ODUs), a plurality of indoor units (IDUs), and a plurality of wireless interfaces, the method comprising:
automatically sending first ODU identification data that uniquely identifies a first ODU from the first ODU to a first IDU that is connected to the first ODU via a first communication line;
sending the first ODU identification data from the first IDU to a first wireless interface connected to the first IDU via a second communication line;
wirelessly sending the first ODU identification data from the first wireless interface to a first group of one or more additional wireless interfaces; and
receiving at the first wireless interface a first set of ODU identification data from the first set of wireless interfaces
wherein
the first ODU is one of the one or more ODUs,
the first IDU is one of the plurality of IDUs,
the first wireless interface is one of the plurality of wireless interfaces,
the first group of wireless interfaces includes all of the plurality of wireless interfaces except for the first wireless interface, and
the first set of ODU identification data identifies for each respective IDU in the first group of wireless interfaces a one of the one or more ODUs that is associated with the respective IDU.

2. The method of claim 1, further comprising:
storing the first ODU identification data in a first IDU memory in the first IDU.

3. The method of claim 1, further comprising:
storing the first ODU identification data in a first wireless interface memory in the first wireless interface.

4. The method of claim 1, wherein
the first ODU identification data includes a model and serial number of the first ODU.

5. The method of claim 1, further comprising:
prior to the sending of the first ODU identification data from the first IDU to the first wireless interface, sending a request from the first wireless interface to the first IDU for transmission of the first ODU identification data.

6. The method of claim 1, wherein
the sending of the first ODU identification data to the first wireless interface is performed automatically by the first IDU.

7. The method of claim 1, further comprising:
automatically sending the first ODU identification data to a second IDU that is connected to the first ODU via a third communication line;
automatically sending the first ODU identification data from the second IDU to a second wireless interface connected to the second IDU via a fourth communication line;
wirelessly sending the first ODU identification data from the second wireless interface to a second group of one or more additional wireless interfaces; and
receiving at the second wireless interface a second set of ODU identification data from the second set of wireless interfaces
wherein
the second IDU is one of the plurality of IDUs,
the second wireless interface is one of the plurality of wireless interfaces,
the second group of wireless interfaces includes all of the plurality of wireless interfaces except for the second wireless interface, and
the second set of ODU identification data identifies for each respective IDU in the second group of wireless interfaces a one of the one or more ODUs that is associated with the respective IDU.

8. The method of claim 1, further comprising:
automatically sending second ODU identification data that uniquely identifies a second ODU from the second ODU to a third IDU that is connected to the second ODU via a fifth communication line;
automatically sending the second ODU identification data from the third IDU to a third wireless interface connected to the third IDU via a sixth communication line;
wirelessly sending the second ODU identification data from the third wireless interface to a third group of one or more additional wireless interfaces; and
receiving at the third wireless interface a third set of ODU identification data from the third set of wireless interfaces
wherein
the second ODU is one of the one or more ODUs,
the third IDU is one of the plurality of IDUs,
the third wireless interface is one of the plurality of wireless interfaces,
the third group of wireless interfaces includes all of the plurality of wireless interfaces except for the third wireless interface, and
the third set of ODU identification data identifies for each respective IDU in the third group of wireless interfaces a one of the one or more ODUs that is associated with the respective IDU.

9. The method of claim 8, wherein
the second ODU identification data includes a model and serial number of the second ODU.

10. The method of claim 1, further comprising:
receiving a demand response communication from an external system at a router wirelessly connected to the first wireless interface;
forwarding the demand response communication to the first wireless interface;
comparing the first ODU identification data with the first set of ODU identification data;
determining a first subset of wireless interfaces from among the first group of wireless interfaces that are connected to the first ODU based on the comparing of the first ODU identification data with the first set of ODU identification data; and
coordinating at the first wireless interface a response to the demand response communication with the first subset of wireless interfaces.

11. The method of claim 10, wherein
the demand response communication limits use of power by the first ODU.

12. The method of claim 10, wherein
the demand response communication sets a maximum temperature offset associated with the first ODU.

13. The method of claim 10, wherein
the demand response communication provides instructions regarding use of a supplemental heating circuit associated with the first ODU.

14. An method of operating a first wireless interface in a heating, ventilating, and cooling (HVAC) system, the method comprising:
receiving first ODU identification data that uniquely identifies a first ODU in the HVAC system from a first IDU that is connected to both the first ODU and the first wireless interface;
wirelessly sending the first ODU identification data to a plurality of additional wireless interfaces associated with the HVAC system; and
receiving a first set of ODU identification data from the plurality of additional wireless interfaces
wherein
the first set of ODU identification data identifies for each corresponding one of the plurality of additional wireless interfaces an ODU that is associated with a respective IDU associated with the corresponding one of the plurality of additional wireless interfaces.

15. The method of claim 14, further comprising:
storing the first ODU identification data in a first wireless interface memory in the first wireless interface.

16. The method of claim 14, wherein
the first ODU identification data includes a model and serial number of the first ODU.

17. The method of claim 14, further comprising:
prior to receiving the first ODU identification data from the first IDU, sending a request to the first IDU for transmission of the first ODU identification data.

18. The method of claim 14, further comprising:
receiving a demand response communication from a router wirelessly in the HVAC system connected to the first wireless interface;
comparing the first ODU identification data with the first set of ODU identification data;
determining a first subset of wireless interfaces from among the plurality of additional wireless interfaces that are connected to the first ODU based on the comparing of the first ODU identification data with the first set of ODU identification data; and
coordinating at the first wireless interface a response to the demand response communication with the first subset of wireless interfaces.

19. The method of claim 10, wherein
the demand response communication limits use of power by the first ODU.

20. The method of claim 10, wherein
the demand response communication sets a maximum temperature offset associated with the first ODU.
